(19) United States
(12) Patent Application Publication
(10) Pub. No.: US 2008/0078739 A1
(43) Pub. Date: Apr. 3, 2008

(54) Method for manufacturing magnetic recording medium

(75) Inventors: Mikiharu Hibi, Saitama-shi (JP); Minoru Fujita, Tokyo (JP); Kazuhiro Hattori, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 11/898,729

(22) Filed: Sep. 14, 2007

(30) Foreign Application Priority Data
Sep. 29, 2006 (JP) 2006-267528

(51) Int. Cl. B44C 1/22

(52) U.S. Cl. 216/22

(57) ABSTRACT

A method for manufacturing a magnetic recording medium with excellent production efficiency is provided in which the recording layer can be processed into a desired concavo-convex pattern with high precision and the resin layer can reliably and thoroughly be removed. A sub-mask layer having corrosion resistance against an oxygen-containing gas is provided over a main mask layer composed mainly of carbon. Furthermore, an intermediate mask layer is provided between the main mask layer and the sub-mask layer. The intermediate mask layer has corrosion resistance against the oxygen-containing gas, and its etching rate is higher for a halogen-containing gas than for the oxygen-containing gas. The resin layer removing step is conducted between the sub-mask layer processing step and the intermediate mask layer processing step (the main mask layer processing step). The resin layer removing step uses the oxygen-containing gas, and the intermediate mask layer processing step uses the halogen-containing gas.

### BACKGROUND OF THE INVENTION

1. Field of the Invention

The present invention relates to a method for manufacturing a magnetic recording medium having a recording layer formed in a concavo-convex pattern.

2. Description of the Related Art

Recently, a magnetic recording medium such as a hard disk and the like has undergone a number of improvements including a reduction in size of the magnetic particles constituting a recording layer, development of new materials, and heightened precision with regard to the processing of the head assembly. Because of these improvements, areal density has been significantly improved, and even further improvement thereof is expected in the future.

However, problems such as limitations with respect to the head processing technology, recording of data to the wrong track, which is adjacent to the target track, due to the spread of the recording magnetic field, and crosstalk during reproducing have emerged, and the improvement of the areal density by conventional improvement methodology has now reached its limit. Accordingly, a discrete track medium or a patterned medium, where a recording layer made of a continuous film of magnetic material is partitioned into a number of recording elements, has been proposed as a candidate of magnetic recording medium capable of further improving the areal density (for example, see Japanese Patent Laid-Open Publication No. Hei 9-97419).

Technologies for processing the recording layer made of a magnetic material into a concavo-convex pattern include reactive ion etching (RIE), which utilizes a CO gas as the reactive gas added to another gas containing nitrogen such as NH₃, RIE, which uses a Cl₂ gas as the reactive gas (for example, see Japanese Patent Laid-Open Publication No. Hei 12-322710), and ion beam etching (IBE), which uses a noble gas such as Ar.

With RIE, it is possible to control the etching rate for the mask layer to make it considerably lower than that of the layer to be processed by selecting an appropriate gas for processing. For this reason, RIE is often used in the field of semiconductor production.

Conversely, for magnetic materials, the various types of reactive gas that can be used to chemically embrittle the magnetic materials are limited to a CO gas which is added to a nitrogen-containing gas or a halogen-containing gas such as a Cl₂ gas as mentioned above.

The CO gas added to the nitrogen-containing gas is likely to cause the process temperature to rise during the processing of the recording layer made of a magnetic material and to therefore deteriorate the magnetic characteristics of the recording layer.

A halogen-containing gas such as Cl₂ and the like can oxidize or corrode the magnetic materials and, hence, is also likely to deteriorate magnetic characteristics of the recording layer.

Because of this peculiarity of the magnetic material, IBE using a noble gas can therefore be considered as another promising candidate for a dry etching technique to be used for processing the recording layer in the field of a magnetic recording medium production.

Since a dry etching technique using a noble gas does not accompany a chemical reaction with the layer to be processed, it is hard to make much difference between the etching rates of the layer to be processed and the mask layer may not result. However, the etching rate of carbon is relatively low for IBE using a noble gas and comes to approximately ¼ to ⅕ of the etching rate of the magnetic material. Therefore, it is preferable that the recording layer made of the magnetic material be etched with the mask layer made of carbon.

In order to process the mask layer into a predetermined pattern, techniques used in the field of semiconductor production such as lithography can be used. Specifically, a resin layer such as a photoresist is formed over a mask layer made of carbon, and the resin layer is processed into a predetermined concavo-convex pattern by lithography or imprinting. Then, based on this resin layer with the concavo-convex pattern, the mask layer can be processed into a concavo-convex pattern corresponding to the concavo-convex pattern.

In order to form a resin layer over the mask layer, a technique such as spin coating, for example, can be used. A typical substrate of a magnetic recording medium such as a hard disk is provided with a center hole for chucking. If a liquid resin is supplied around the center hole and the substrate is rotated, then the resin is spread over the entire surface of the substrate by centrifugal force.

Moreover, in order to etch the mask layer made of carbon into the concavo-convex pattern based on the concavo-convex pattern of the resin layer, RIE can be employed where an oxygen-containing gas or a halogen-containing gas that reacts chemically with carbon is used.

However, since the oxygen-containing gas and the halogen-containing gas also react chemically with the resin layer, the etching rate is high not only for the mask layer made of carbon but also for the resin layer.

In order to solve this problem, other techniques have been proposed where a sub-mask layer is provided between the main mask layer made of carbon and the resin layer. This sub-mask layer has an etching rate that is lower than that of the main mask layer made of carbon with respect to an oxygen-containing gas or a halogen-containing gas. Then, for example, the sub-mask layer is etched by IBE using a noble gas based on the concavo-convex pattern of the resin layer, and next, the main mask layer is etched by RIE using an oxygen-containing gas or a halogen-containing gas based on the pattern of the sub-mask layer. Then., the recording layer is etched by IBE using a noble gas based on the pattern of the main mask layer (for example, see Japanese Patent Laid-Open Publication No. 2005-50468).

A filler is deposited over the recording layer that has been processed into the concavo-convex pattern so that the concave portions between the recording elements are filled with the filler. Then, surplus portions of the filler above the recording elements are removed by IBE or the like to flatten the surface of the recording elements and the filler.

In order to manufacture a magnetic recording medium having less contamination by foreign objects, it is preferable that the main mask layer, the sub-mask layer, and the resin layer remaining over the recording elements be thoroughly removed after the processing of the recording layer. In particular, in order to manufacture a magnetic recording medium having a flattened surface, it is preferable that the main mask layer, the sub-mask layer, and the resin layer remaining over the recording elements be thoroughly removed before a filler is deposited over the recording layer. In order to remove the main mask layer made of carbon, a dry etching technique using an oxygen-containing gas or a halogen-containing gas can be employed.

The removal of the main mask layer may result in the removal of the sub-mask layer and the resin layer located thereon. Alternatively, the resin layer and the sub-mask layer may be removed during the processing of the main mask layer or the recording layer before the removal of the main mask layer.

However, in a step for forming a resin layer wherein a resin is spread over a substrate by, for example, a spin coating technique, thicknesses of the resin layer may differ at different locations over the substrate. Consequently, this can result in a resin layer which is significantly thick partly. For example, the thickness of the resin layer in a region surrounding the center hole may be several times thicker than other regions.

Because of this, the resin layer sometimes cannot be thoroughly removed after the processing of the recording layer. In such a case, there are concerns about the resin remaining in the finished product. Moreover, portions of the resin layer remaining over the recording elements may cause a variety of problems during later processes such as a filler depositing step, a flattening step, and the like. In other words, the reliability of the product can be reduced.

It should be noted that, as mentioned above, the resin layer becomes embrittled through a chemical reaction with an oxygen-containing gas or a halogen-containing gas, just like the main mask layer made of carbon does. Therefore, a processing time maybe selected that is sufficiently long for the step of processing the main mask layer with either of these gases to ensure that the resin layer is thoroughly removed. However, as mentioned above, the thickness of the resin layer may be significantly larger at some locations in comparison to that of the main mask layer made of carbon. Therefore, if a processing time for the main mask layer processing step is extended to a duration such that the resin layer, whose thickness is significantly large at some locations, can be thoroughly removed, then the etching of the main mask layer in the width direction of the concave portion may become excessive. This results in the concave portion whose width is inappropriately enlarged, causing problems associated with degraded processing precision of the recording layer.

Alternatively, during the step for removing the main mask layer made of carbon with an oxygen-containing gas or a halogen-containing gas after the processing of the recording layer, a processing time for this step may be extended to a duration such that the resin layer is thoroughly removed. However, such an arrangement exposes the recording layer to the oxygen-containing gas or the halogen-containing gas for an extended period of time so that oxidation or corrosion of the recording layer progresses to deteriorate its magnetic characteristics. In particular, if the recording layer contains a non-oxide based magnetic material, the deterioration of its magnetic characteristics becomes significant.

As another alternative, a wet etching technique may be used to remove the resin layer. However, if a wet etching step is to be carried out between the dry etching steps for processing respective layers, then the manufacturing steps as well as the manufacturing facilities become complicated, thereby significantly reducing production efficiency. In other words, an object to be processed will need to be temporarily taken out of the dry processing facility, such as a vacuum chamber, and placed in the wet etching facility. The object to be processed is then subjected to wet etching, after which it is taken out of the wet processing facility, and placed back in the dry processing facility again. Furthermore, when the object to be processed is being taken out of the vacuum chamber or the like, problems associated with contamination by foreign objects or oxidation of the recording layer are likely to occur, deteriorating the reliability of the product.

### SUMMARY OF THE INVENTION

In view of the foregoing problems, various exemplary embodiments of this invention provide a method for manufacturing a magnetic recording medium with excellent production efficiency, where the recording layer can be processed into a desired concavo-convex pattern with high precision and the resin layer can be reliably and thoroughly removed.

The above-mentioned object may be achieved by the following method. An intermediate mask layer is provided between a main mask layer composed mainly of carbon and a sub-mask layer having corrosion resistance against dry etching using an oxygen-containing gas. This intermediate mask layer has corrosion resistance against the dry etching using the oxygen-containing gas, and its etching rate is higher for dry etching using a halogen-containing gas than for the dry etching using the oxygen-containing gas. The sub-mask layer is processed into a concavo-convex pattern based on the resin layer by dry etching. Next, the resin layer remaining over the sub-mask layer is removed by the dry etching using the oxygen-containing gas. The intermediate mask layer is then processed into a concavo-convex pattern corresponding to the concavo-convex pattern based on the sub-mask layer by the dry etching using the halogen-containing gas. Next, the main mask layer is processed into a concavo-convex pattern corresponding to the concavo-convex pattern based on at least one of the sub-mask layer and the intermediate mask layer by dry etching. Lastly, the recording layer is processed into a concavo-convex pattern corresponding to the concavo-convex pattern based on the main mask layer by dry etching. In this instance, the etching rate of the sub-mask layer for the dry etching using the halogen-containing gas is lower than that of the intermediate mask layer.

Alternatively, the above-mentioned object may also be achieved by the following method. An intermediate mask layer is provided between a main mask layer composed mainly of carbon and a sub-mask layer having corrosion resistance against dry etching using a first halogen-containing gas containing either one of F and Cl. This intermediate mask layer has corrosion resistance against the dry etching using the first halogen-containing gas, and its etching rate is higher for dry etching using a second halogen-containing gas containing the other one of F and Cl than for the dry etching using the first halogen-containing gas. The sub-mask layer is processed into a concavo-convex pattern based on the resin layer by dry etching. Next, the resin layer remaining over the sub-mask layer is then removed by dry etching using the first halogen-containing gas. The intermediate mask layer is then processed into a concavo-convex pattern corresponding to the concavo-convex pattern based on the sub-mask layer by the dry etching using the second halogen-containing gas. Next, the main mask layer is processed into a concavo-convex pattern corresponding to the concavo-convex pattern based on at least one of the sub-mask layer and the intermediate mask layer by dry etching. Lastly, the recording layer is processed into a concavo-convex pattern corresponding to the concavo-convex pattern based on the main mask layer by dry etching. In this instance, the etching rate of the sub-mask layer for the dry etching using the second halogen-containing gas is lower than that of the intermediate mask layer.

It should be noted that the intermediate mask layer processing step may also preferably serve as the main mask layer processing step and that both the intermediate mask layer and the main mask layer may preferably be processed based on the sub-mask layer in the intermediate mask layer processing step.

As described above, different reactive gases are used in the resin layer removing step and the intermediate mask layer processing step. Moreover, the sub-mask layer having corrosion resistance against the reactive gas of the resin layer removing step is provided over the main mask layer composed mainly of carbon. Furthermore, the intermediate mask layer is provided between the main mask layer and the sub-mask layer. This intermediate mask layer has corrosion resistance against the reactive gas of the resin layer removing step, and its etching rate is higher for the reactive gas of the intermediate mask layer processing step than for the reactive gas of the resin layer removing step. The resin layer removing step is then conducted between the sub-mask layer processing step and the intermediate mask layer processing step. Accordingly, the resin layer can be completely removed while protecting the main mask layer against the process used for removing the resin layer. Hence, the main mask layer can be processed into a desired shape with high precision during the main mask layer processing step, thereby contributing to an improvement in processing precision of the recording elements.

Moreover, by providing the intermediate mask layer processing step also serving as the main mask layer processing step, the production efficiency can be improved.

Furthermore, since the main mask layer is mainly composed of carbon, the main mask layer remaining over the recording elements can be removed by dry etching using neither an oxygen-containing gas nor a halogen-containing gas but a hydrogen-containing gas in the main mask layer removing step. This prevents the magnetic characteristics of the recording layer from being deteriorated.

Accordingly, various exemplary embodiments of this invention provide

a method for manufacturing a magnetic recording medium comprising:

a preparation step for preparing a starting body of an object to be processed, the object including a substrate, a recording layer of continuous film made of a magnetic material, a main mask layer composed mainly of carbon, an intermediate mask layer having corrosion resistance against dry etching using an oxygen-containing gas, an etching rate of the intermediate mask layer being higher for dry etching using a halogen-containing gas than for the dry etching using the oxygen-containing gas, a sub-mask layer having corrosion resistance against the dry etching using the oxygen-containing gas, an etching rate of the sub-mask layer for the dry etching using the halogen -containing gas being lower than that of the intermediate mask layer, and a resin layer having a property that it is removed by the dry etching using the oxygen-containing gas, wherein these layers are formed in this order over the substrate;

a resin layer processing step for processing the resin layer into a predetermined concavo-convex pattern;

a sub-mask layer processing step for processing the sub-mask layer into a concavo-convex pattern corresponding to the concavo-convex pattern based on the resin layer by dry etching;

a resin layer removing step for removing a portion of the resin layer remaining over the sub-mask layer by the dry etching using the oxygen-containing gas;

an intermediate mask layer processing step for processing the intermediate mask layer into a concavo-convex pattern corresponding to the concavo-convex pattern based on the sub-mask layer by the dry etching using the halogen-containing gas;

a main mask layer processing step for processing the main mask layer into a concavo-convex pattern corresponding to the concavo-convex pattern based on at least one of the sub-mask layer and the intermediate mask layer by dry etching; and

a recording layer processing step for processing the recording layer into a concavo-convex pattern corresponding to the concavo-convex pattern based on the main mask layer by dry etching, convex portions of the concavo-convex pattern providing recording elements, wherein

these steps are conducted in this order.

Alternatively, various exemplary embodiments of this invention provide

a method for manufacturing a magnetic recording medium comprising:

a preparation step for preparing a starting body of an object to be processed, the object including a substrate, a recording layer of continuous film made of a magnetic material, a main mask layer composed mainly of carbon, an intermediate mask layer having corrosion resistance against dry etching using a first halogen-containing gas containing either one of F and Cl, an etching rate of the intermediate mask layer being higher for dry etching using a second halogen-containing gas containing the other one of F and Cl than for the dry etching using the first halogen-containing gas, a sub-mask layer having corrosion resistance against the dry etching using the first halogen-containing gas, an etching rate of the sub-mask layer for the dry etching using the second halogen-containing gas being lower than that of the intermediate mask layer, and a resin layer having a property that it is removed by the dry etching using the first halogen-containing gas, wherein these layers are formed in this order over the substrate;

a resin layer processing step for processing the resin layer into a predetermined concavo-convex pattern;

a sub-mask layer processing step for processing the sub-mask layer into a concavo-convex pattern corresponding to the concavo-convex pattern based on the resin layer by dry etching;

a resin layer removing step for removing a portion of the resin layer remaining over the sub-mask layer by the dry etching using the first halogen-containing gas;

an intermediate mask layer processing step for processing the intermediate mask layer into a concavo-convex pattern corresponding to the concavo-convex pattern based on the sub-mask layer by the dry etching using the second halogen-containing gas;

a main mask layer processing step for processing the main mask layer into a concavo-convex pattern corresponding to the concavo-convex pattern based on at least one of the sub-mask layer and the intermediate mask layer by dry etching; and

a recording layer processing step for processing the recording layer into a concavo-convex pattern corresponding to the concavo-convex pattern based on the main mask layer by dry etching, convex portions of the concavo-convex pattern providing recording elements, wherein

these steps are conducted in this order.

In the present application, the phrase “composed mainly of carbon” should be understood to mean a case where the ratio of the number of carbon atoms to the number of atoms of all constituent elements is 70% or greater.

Moreover, in the present application, the term “oxygen-containing gas” should be understood to mean a gas containing at least either one of O₂ and O₃. Furthermore, “oxygen-containing gas” is not limited to those gases comprising only O₂ or O₃ but should also be understood to include those gases mixed with other gases such as an N₂ gas and a noble gas in addition to O₂ or O₃.

Moreover, in the present application, the term “halogen-containing gas” should be understood to mean a gas containing a halogen element such as F, Cl, or Br or a halogen-based compound. Furthermore, “halogen-containing gas” is not limited to those gases comprising only a halogen element or a halogen-based compound but should be understood to include those gases mixed with other gases such as an N₂ gas or a noble gas in addition to the halogen element or the halogen-based compound.

Moreover, in the present application, the term “hydrogen-containing gas” should be understood to mean a gas containing H, such as H₂ and NH₃. Furthermore, “hydrogen-containing gas” is not limited to those gases comprising only H₂ or NH₃ but should be understood to include those gases mixed with other gases such as an N₂ gas or a noble gas in addition to H₂ or NH₃.

Moreover, in the present application, the term “magnetic recording medium” should be understood to mean not only a recording medium for which recording-and reproducing of information are achieved only magnetically, such as a hard disk, a floppy (registered trademark) disk, and a magnetic tape, but also a magneto optical recording medium that uses magnetism and light, such as an MO, and a recording medium with thermal assistance that uses magnetism and heat.

According to various exemplary embodiments of the present invention, the recording layer can be processed into a desired concavo-convex pattern with high precision, and the resin layer can be removed reliably, thoroughly, and efficiently.

### BRIEF DESCRIPTION OF THE DRAWINGS

FIG. 1 is a cross-sectional side view schematically illustrating the configuration of a starting body of an object to be processed during manufacturing steps for a magnetic recording medium according to a first exemplary embodiment of the present invention;

FIG. 2 is a cross-sectional side view schematically illustrating the configuration of a magnetic recording medium obtained by processing the object to be processed;

FIG. 3 is a flow chart showing an outline of the manufacturing steps of the magnetic recording medium;

FIG. 4 is a cross-sectional side view schematically illustrating a shape of the object to be processed where a concavo-convex pattern has been transferred onto a resin layer;

FIG. 5 is a cross-sectional side view schematically illustrating a shape of the object to be processed where portions of the resin layer at the bottoms of concave portions have been removed;

FIG. 6 is a cross-sectional side view schematically illustrating a shape of the object to be processed where the sub-mask layer has been processed into a concavo-convex pattern;

FIG. 7 is a cross-sectional side view schematically illustrating a shape of the object to be processed where the resin layer has been removed;

FIG. 8 is a cross-sectional side view schematically illustrating a shape of the object to be processed where portions of the intermediate mask layer and the main mask layer at the bottoms of the concave portions have been removed;

FIG. 9 is a cross-sectional side view schematically illustrating a shape of the object to be processed where portions of the recording layer at the bottoms of the concave portions have been removed;

FIG. 10 is a cross-sectional side view schematically illustrating a shape of the object to be processed where the main mask layer has been removed;

FIG. 11 is a cross-sectional side view schematically illustrating a shape of the object to be processed where filler has been deposited over the recording layer;

FIG. 12 is a cross-sectional side view schematically illustrating a shape of the object to be processed where surfaces of the recording elements and the filler have been flattened;

FIG. 13 is a flow chart showing an outline of manufacturing steps of the magnetic recording medium according to a second exemplary embodiment of the present invention;

FIG. 14 is a photograph taken under an optical microscope showing under magnification a periphery part of a center hole of a starting body of an object to be processed in manufacturing steps of a magnetic recording medium according to Working Example of the present invention;

FIG. 15 is a photograph taken under an optical microscope showing under magnification the periphery part of the center hole of the object to be processed after a main mask layer removing step;

FIG. 16 is a photograph taken under SEM (scanning electron microscope) showing a burst signal pattern of a recording layer in a servo region of the object to be processed after the main mask layer removing step;

FIG. 17 is a photograph taken under an optical microscope showing under magnification a periphery part of a center hole of an object to be processed in manufacturing steps of a magnetic recording medium according to Comparative Example 1 after a main mask layer removing step; and

FIG. 18 is a photograph taken under SEM showing under magnification a burst signal pattern of a recording layer in a servo region of an object to be processed in manufacturing steps of a magnetic recording medium according to Comparative Example 2 after a main mask layer removing step.

### DETAILED DESCRIPTION OF THE PREFERRED EMBODIMENTS

Hereinafter, preferred exemplary embodiments of the present invention will be described with reference to the drawings.

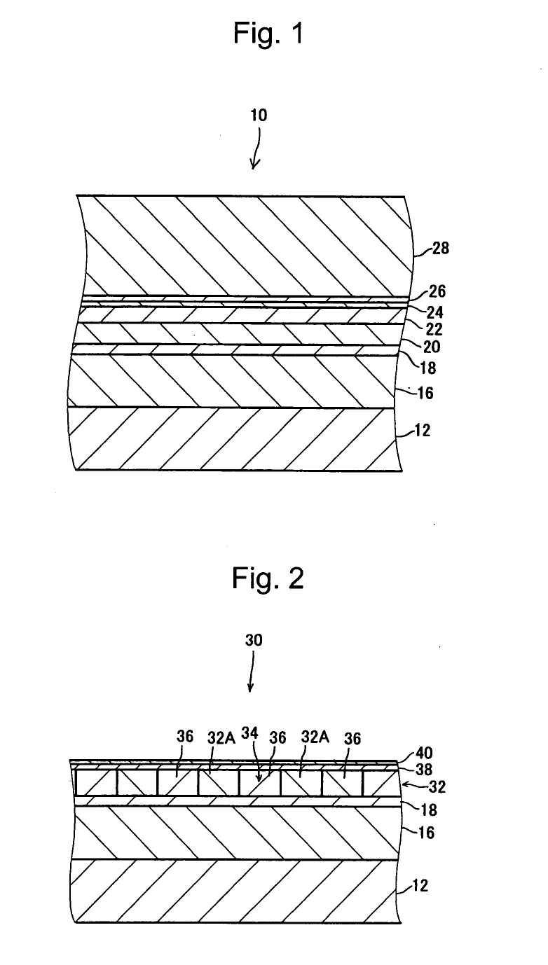

The first exemplary embodiment of the present invention relates to a method for manufacturing a magnetic recording medium, wherein a starting body of an object to be processed 10 shown in FIG. 1 is processed by a dry etching technique or the like and the recording layer formed of a continuous film is processed into a predetermined line-and-space pattern (data track pattern) as shown in FIG. 2 and a servo pattern (not shown in the figure). The first exemplary embodiment is characterized by a material for the mask layers that coat the continuous film recording layer and processing and removal methods therefor. Other constructions that are not considered to be significant for understanding the first exemplary embodiment of the present invention, are omitted where deemed unnecessary.

As shown in FIG. 1, the starting body of the object to be processed 10 includes a substrate 12, a soft magnetic layer 16, a seed layer 18, a recording layer 20 of a continuous film mainly composed of a magnetic material, a main mask layer 22, an intermediate mask layer 24, a sub-mask layer 26, and a resin layer 28. These layers are formed over the substrate 12 in this order. The intermediate mask layer 24 has corrosion resistance against dry etching using an oxygen-containing gas, and its etching rate is higher for dry etching using a halogen-containing gas than for the dry etching using the oxygen-containing gas. The sub-mask layer 26 has corrosion resistance against the dry etching using the oxygen-containing gas, and its etching rate for the dry etching using the halogen-containing gas is lower than those of the main mask layer 22 and the intermediate mask layer 24. The resin layer 28 has a property that it is removed by the dry etching using the oxygen-containing gas.

The substrate 12 is made of glass and has a disk-like shape (not shown) with a center hole. Other materials such as Al and Al₂O₃ may also be used for the substrate 12 provided that they are a non-magnetic material with sufficient rigidity. The soft magnetic layer 16 has a thickness of 50 to 300 nm and is composed of a Fe alloy or a Co alloy. The seed layer 18 has a thickness of 2 to 40 nm and is made of a non-magnetic CoCr-based alloy, Ti, Ru, a layered structure of Ru and Ta, MgO, or the like.

The recording layer 20 has a thickness of 5 to 30 nm and is composed of a CoCr-based alloy such as a CoCrPt alloy, a FePt-based alloy, a layered structure thereof, or a material composed of ferromagnetic particles such as CoPt mixed in an oxide material such as SiO₂ in a matrix configuration.

The main mask layer 22 has a thickness of 3 to 50 nm and is composed of C (carbon). The main mask layer 22 can also be made of a hard carbon film, which is sometimes referred to as diamond-like carbon (hereinafter, referred to as “DLC”).

The intermediate mask layer 24 has a thickness of 2 to 10 nm and is composed of Si, Au, SiO₂, Ta, TaSi, TiN, Ti, W, Al, Al₂O₃, Cu, or the like.

The sub-mask layer 26 has a thickness of 2 to 30 nm and is composed of Ni, Cu, Cr, Al, Al₂O₃, Ta, or the like. It should be appreciated that the sub-mask layer 26 and the intermediate mask layer 24 are made of different materials.

The resin layer 28 has a thickness of 30 to 300 nm and is composed of an acrylic resin or the like.

The magnetic recording medium 30 is a perpendicular recording type discrete track medium having a disk-like shape provided with a center hole. The recording layer 32 has a concavo-convex pattern as shown in FIG. 2, which is obtained by partitioning the above-mentioned continuous film recording layer 20 so as to include a plurality of recording elements 32A of a concentric circular arc configuration with a minute spacing therebetween in the radial direction in a data region. Incidentally, the recording layer 32 includes a plurality of recording elements in a predetermined servo pattern in a servo region (not shown). The concave portions 34 between the recording elements 32A are filled with a filler 36. A protective layer 38 and a lubrication layer 40 are formed in this order over the recording elements 32A and the filler 36.

The filler 36 is formed of SiO₂ or the like. The protective layer 38 has a thickness of 1 to 5 nm and is formed of the above-mentioned DLC. The lubrication layer 40 has a thickness of 1 to 2 nm and is formed of PFPE (perfluoro polyether).

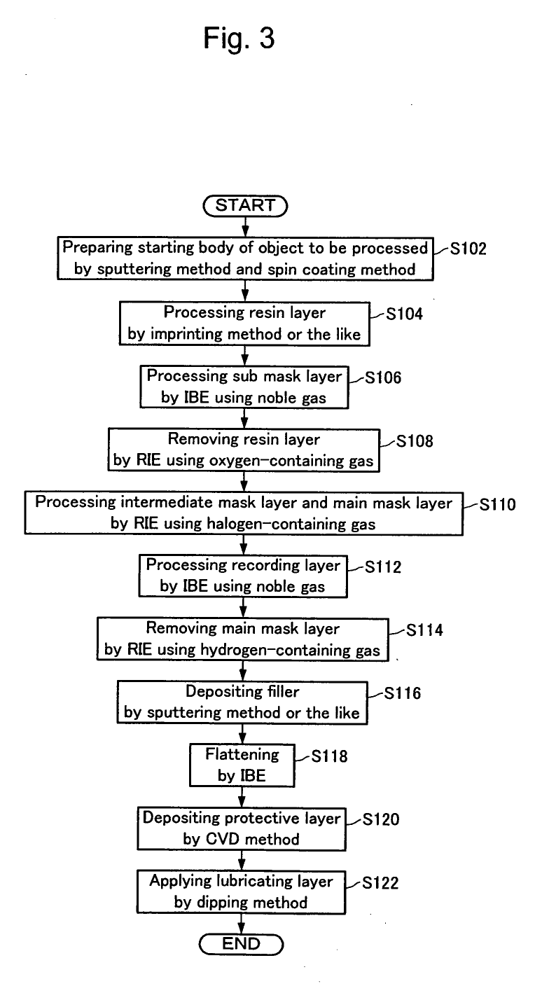

A method for manufacturing the magnetic recording medium 30 will now be described with reference to the flow chart shown in FIG. 3 and the like.

First, a starting body of an object to be processed 10 is prepared (S102). The starting body of the object to be processed 10 is obtained by forming the soft magnetic layer 16, the seed layer 18, the recording layer 20 of the continuous film, the main mask layer 22, the intermediate mask layer 24, and the sub-mask layer 26 over the substrate 12 in this order by a sputtering method, and then forming the resin layer 28 thereon by a spin coating method. When forming the DLC as the main mask layer 22, a CVD method is used. In the step for forming the resin layer 28, a liquid resin as a raw material is supplied in the vicinity of the center hole of the substrate 12, and the substrate 12 is rotated so that the liquid resin spreads across the entire surface of the substrate 12. The spread resin is then subjected to a baking process or the like to remove any solvent and is then set to a predetermined hardness.

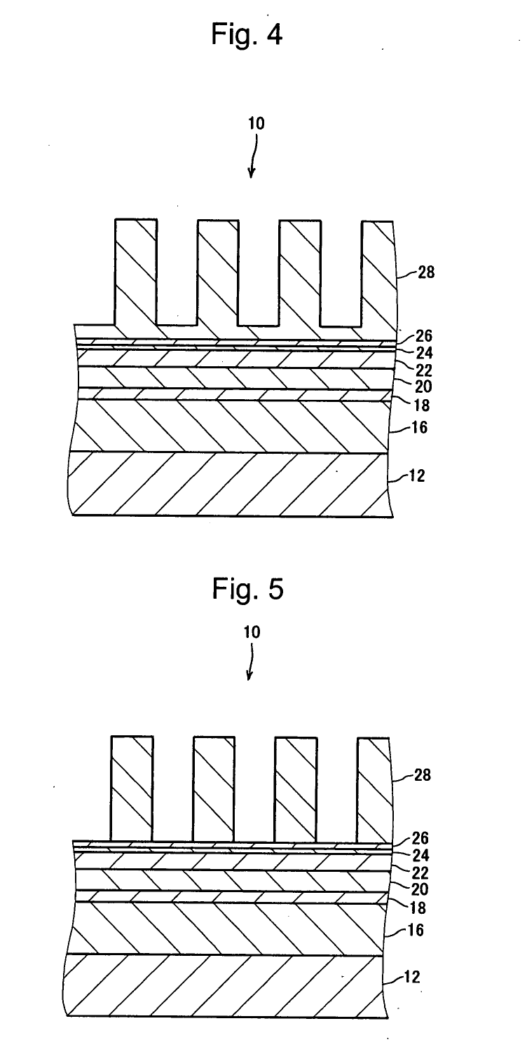

The resin layer 28 of the starting body of the object to be processed 10 is then processed into a concavo-convex pattern corresponding to the partitioning pattern of the recording elements 32A (S104). Specifically, a concavo-convex pattern corresponding to the partitioning pattern of the recording elements 32A is transferred onto the resin layer 28 as illustrated in FIG. 4 by bringing the transfer surface of the stamper (not shown) into contact with the resin layer 28 by an imprinting method. This imprinting method is capable of transferring the concavo-convex pattern onto the resin layer 28 in an efficient manner. Next, the object to be processed 10 with the concavo-convex pattern having been transferred thereon is mounted on a holder (not shown) and placed inside a vacuum chamber (not shown). Then, the object to be processed 10 is automatically conveyed around to processing apparatuses within the vacuum chamber by a conveyer (not shown in the figure). First, portions of the resin layer 28 at the bottom of each of the concave portions are removed by RIE using an oxygen-containing gas. In this instance, although convex portions of the resin layer 28 are also partially removed, the convex portions remain by an amount corresponding to the height of the step of the concavo-convex pattern transferred by the imprinting method. This step completes the processing of the resin layer 28 into a concavo-convex pattern corresponding to the partitioning pattern of the recording elements 32A as shown in FIG. 5. The processing of the resin layer 28 into the concavo-convex pattern corresponding to the partitioning pattern of the recording layer 32A may also be conducted by electron beam lithography or the like.

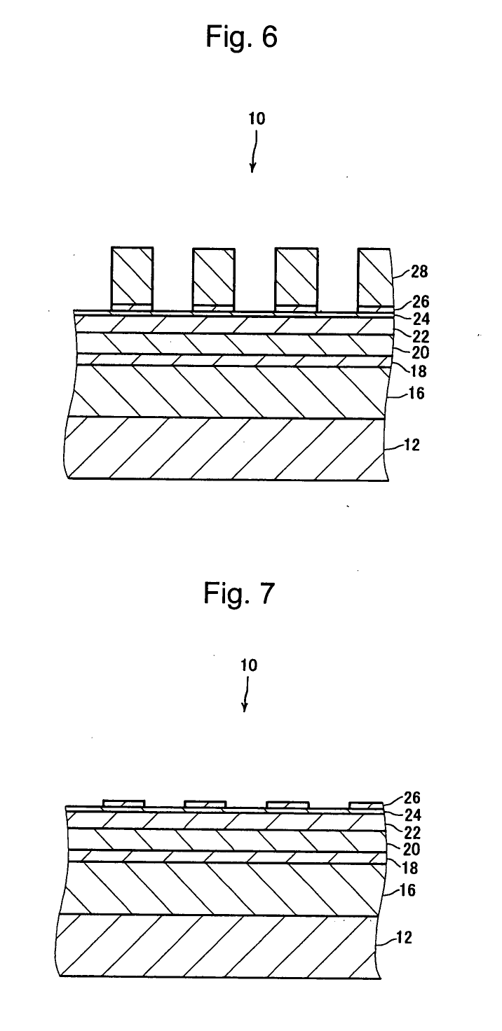

Next, portions of the sub-mask layer 26 at the bottom of each of the concave portions are removed based on the resin layer 28 of the concavo-convex pattern by IBE using a noble gas such as Ar, Kr, Xe, and the like, so that the sub-mask layer 26 is processed into a concavo-convex pattern corresponding to the concavo-convex pattern as shown in FIG. 6 (S106). It should be noted that in the present application, the term “IBE” should be understood to collectively mean a processing method where the object to be processed is irradiated with an ionized gas to remove a portion thereof. Example of the method includes a processing method where the object to be processed is evenly irradiated with an ionized gas, for example, what is called an ion milling method. Accordingly, the term is not limited to processing methods where an ion beam is focused and directed.

Next, the portions of the resin layer 28 remaining over the sub-mask layer 26 are removed by RIE using the oxygen-containing gas, as shown in FIG. 7 (S108). Specifically, the oxygen-containing gas is either O₂ or O₃, whose reactivity can be enhanced by using it in the form of plasma. Although portions of the intermediate mask layer 24 are exposed at the bottom of each of the concave portions, they are hardly etched in this etching step because the intermediate mask layer 24 has corrosion resistance against dry etching using the oxygen-containing gas. In the case where the top portions of the intermediate mask layer 24 located at the bottoms of the concave portions were removed, they would not be removed completely, and the intermediate mask layer 24 would remain over the entire area of the bottom of each concave portion. Therefore, the main mask layer 22 under the intermediate mask layer 24 is protected against this etching process. It should be noted that since the sub-mask layer 26 also has corrosion resistance against the oxygen-containing gas, it is hardly etched in this etching step. Furthermore, even when the top portions of the sub-mask layer 26 were removed, the sub-mask layer 26 constituting the convex portions would not be removed completely, and would remain over the intermediate mask layer 24.

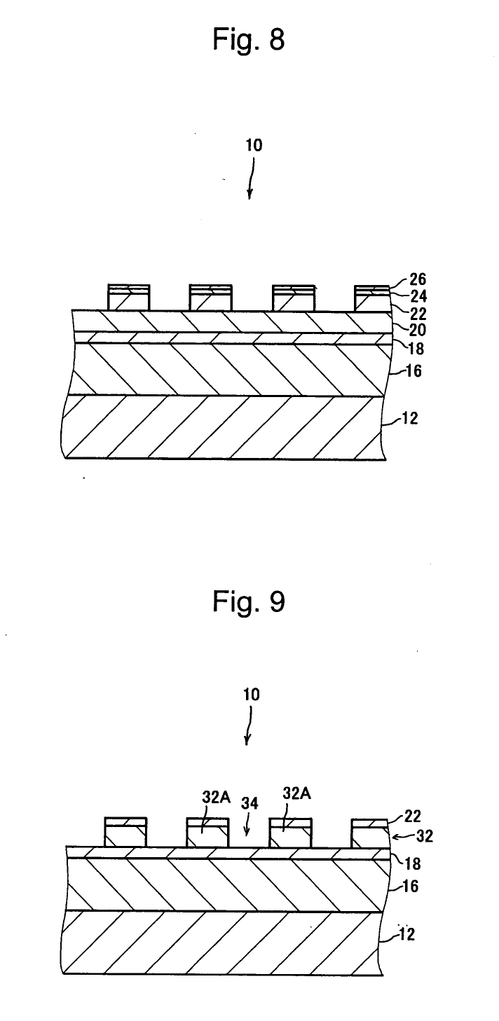

Next, portions of the intermediate mask layer 24 and the main mask layer 22 at the bottom of each of the concave portions are removed as shown in FIG. 8 by RIE using the halogen-containing gas based on the sub-mask layer 26 of the concavo-convex pattern. Accordingly, the intermediate mask layer 24 and the main mask layer 22 are processed into a concavo-convex pattern corresponding to the concavo-convex pattern (S110). Specific examples of the halogen-containing gas include those that can be expressed as CₓF_{y} (where both x and y are integers equal to or greater than 1) such as CF₄, C₂F₆, C₃F₆, C₃F₈, C₄F₆, C₄F₈, and C₅F₈, SF₆, CClF₃, CCl₂F₄, CHF₃, CBrF₃, CCl₄, BCl₃, Cl₂, a mixed gas of SiCl₄ and N₂, a mixed gas of CCl₄ and Ar, and the like. These halogen-containing gases have a property that they react chemically with carbon or a predetermined resin such as an acrylic resin, and embrittle it. Since the intermediate mask layer 24 has a high etching rate for the halogen-containing gas, it can be easily removed. Since the main mask layer 22, which is composed of carbon, also has a high etching rate for the halogen-containing gas, it can be easily removed, too.

Preferred combinations of a material for the intermediate mask layer 24, a material for the sub-mask layer 26, the oxygen-containing gas used in the resin layer removing step (S108), and the halogen-containing gas used in the intermediate mask layer processing step (the main mask layer processing step) (S110) are shown in Table 1.

TABLE 1

| | halogen-containing | | | |
|---|---|---|---|---|
| | gas | | | |
| oxygen- | (for processing | | | |
| containing gas | main mask layer | | | main |
| (for removing | and intermediate | sub mask | intermediate | mask |
| resin layer) | mask layer) | layer | mask layer | layer |
| O₂, O₃ | CxFy, SF₆, | Ni | Si | C |
| | CCl₄, CClF₃ | | | |
| | CxFy, SF₆ | Cu, Cr, Al, | | |
| | | Al₂O₃ | | |
| | CCl₄, CClF₃ | Ta | | |
| | CCl₂F₄, CClF₃ | Ni | Au | |
| | CxFy, CHF₃ | Ni, Cu, Cr, | SiO₂ | |
| | CxFy, SF₆ | Al, Al₂O₃ | Ta, TaSi, | |
| | | | TiN | |
| | CBrF₃, CF₄ | | Ti | |
| | SF₆, CF₄ | | W | |
| | CCl₄, BCl₃, Cl₂ | Ni, Ta | Al | |
| | Cl₂ | | Al₂O₃ | |
| | SiCl₄ + N₂, | | Cu | |
| | CCl₄ + Ar | | | |

As shown in Table 1, when the intermediate mask layer 24 is made of Si or Au, gases containing either F or Cl or both F and Cl can be used as the halogen-containing gas for the intermediate mask layer processing step (being the main mask layer processing step) (S110).

When the intermediate mask layer 24 is made of SiO₂, Ta, TaSi, TiN, Ti, or W, gases containing F can be used as the halogen-containing gas for the intermediate mask layer processing step (being the main mask layer processing step) (S110).

Alternatively, when the intermediate mask layer 24 is made of Al, Al₂O₃, or Cu, gases containing Cl can be used as the halogen-containing gas for the intermediate mask layer processing step (being the main mask layer processing step) (S110).

Next, portions of the recording layer 20 of the continuous film at the bottom of each of the concave portions are removed by IBE using a noble gas such as Ar or the like based on the main mask layer 22 (S112). Accordingly, the recording layer 20 of the continuous film is partitioned into a plurality of recording elements 32A, thereby forming the recording layer 32 of the concavo-convex pattern, as shown in FIG. 9. The sub-mask layer 26 over the recording element 32A is completely removed in this step. The intermediate mask layer 24 over the recording element 32A may also be completely removed depending on its thickness and a material which it is made of. However, the intermediate mask layer 24 may be allowed to remain over the recording element 32A, provided that the recording element 32A is formed with high precision. Even when a portion of the main mask layer 22 over the recording element 32A is removed along with the complete removal of the intermediate mask layer 24, a predetermined amount of the main mask layer 22 must remain over the recording element 32A. It should be noted that in the description of the present application, the expression “processing the recording layer based on the main mask layer” will be used even when the etching of the recording layer 20 of the continuous film is initiated with the intermediate mask layer 24, the sub-mask layer 26, or other layers remaining over the main mask layer 22.

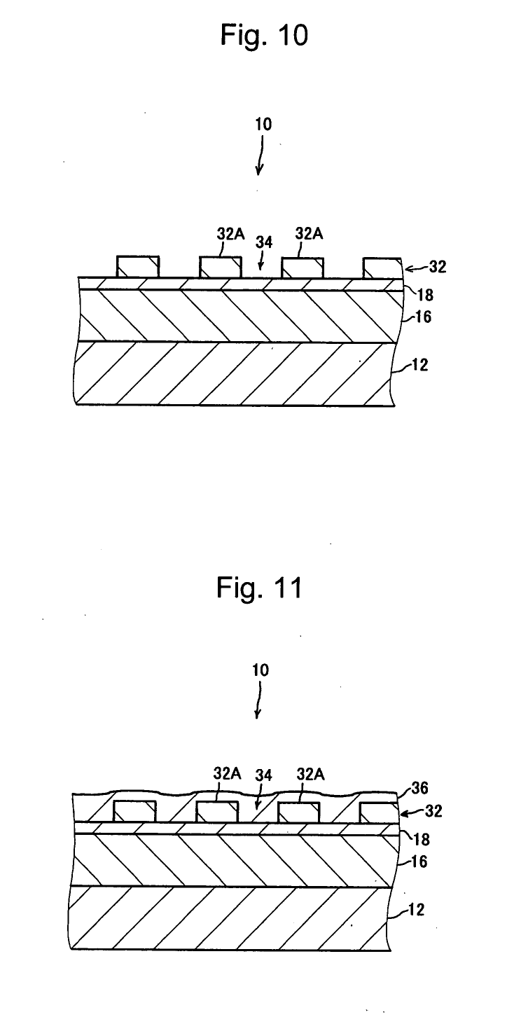

Next, the main mask layer 22 remaining over the recording element 32A is completely removed by RIE using a hydrogen-containing gas as shown in FIG. 10 (S114). Specific examples of the hydrogen-containing gas include NH₃, H₂, and the like. These hydrogen-containing gases have a property that they embrittle carbon by chemically reacting with it.

Next, the filler 36 is deposited over the recording layer 32 having the concavo-convex pattern by sputtering or bias sputtering so that the concave portions 34 between the recording elements 32A are filled with the filler 36 (S116).

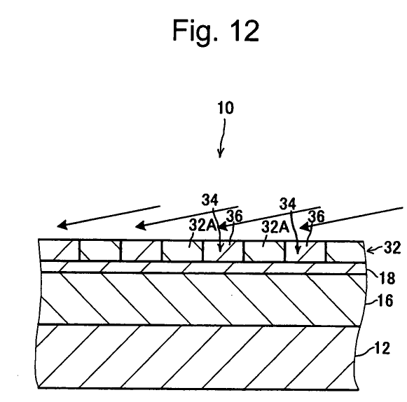

Next, portions of the filler 36 that exist on upper side (opposite side to the substrate 12) than upper surfaces of the recording elements 32A are removed by IBE using a noble gas such as Ar or the like so that the surfaces of the recording elements 32A and the filler 36 are flattened as shown in FIG. 12 (S118). When this is being done, it is preferable that an incident angle of the ions of the noble gas be in a range from −10 to 15° in order to carry out flattening with high precision. Conversely, if an excellent flat surface of the filler 36 has already been obtained is in the filler deposition step (S116), then an incident angle of the ions of the noble gas may be in a range from 30 to 90°. In this way, the processing rate increases, and production efficiency improves. The arrows shown in FIG. 12 schematically illustrate the incident direction of the ion beam. In this instance, the “incident angle” is defined to be an entry angle with respect to the surface of the object to be processed 10, namely, an angle formed by the surface of the object to be processed 10 and the center axis of the ion beam. For example, when the center axis of the ion beam is parallel with the surface of the object to be processed 10, the incident angle is 0°.

Next, the protective layer 38 is formed over the recording elements 32A and the fillers 36 by a CVD method (S120). The object to be processed 10 is then taken out of the vacuum chamber and dismounted from the holder.

Following that, the lubrication layer 40 is applied over the protective layer 38 by a dipping method (S122). Accordingly, the magnetic recording medium 30, as shown in previous FIG. 2, is obtained.

As described above, the sub-mask layer 26 having corrosion resistance against dry etching using an oxygen-containing gas is provided over the main mask layer 22 composed mainly of carbon, and the intermediate mask layer 24 is further provided between the main mask layer 22 and the sub-mask layer 26. The intermediate mask layer 24 has corrosion resistance against the dry etching using the oxygen-containing gas, and its etching rate is higher for the dry etching using a halogen-containing gas than for the dry etching using the oxygen-containing gas. The resin layer removing step (S108) is conducted between the sub-mask layer processing step (S106) and the intermediate mask layer processing step (being the main mask layer processing step) (S110). The oxygen-containing gas is used in the resin layer removing step (S108) and the halogen-containing gas is used in the intermediate mask layer processing step (being the main mask layer processing step) (S110). Accordingly, the resin layer 28 can be completely removed in the resin layer removing step (S108) while simultaneously protecting the main mask layer 22. As a result, the main mask layer 22 can be processed into a desired pattern with high precision in the intermediate mask layer processing step (being the main mask layer processing step) (S110), thereby contributing to the improvement of processing precision of the recording elements 32A.

Moreover, since an oxygen-containing gas that is highly reactive with the resin layer is used in the resin layer removing step (S108), the resin layer can be removed with greater efficiency.

Furthermore, the main mask layer 22 is mainly composed of carbon, and its etching rate against dry etching using a noble gas is lower than that of the recording layer 20 (32) made of a magnetic material. Therefore, the thickness of the main mask layer 22 can be reduced accordingly, also contributing to the improvement of processing precision of the recording elements 32A.

Moreover, since the recording layer is processed into a concavo-convex pattern by dry etching using a noble gas, the magnetic properties of the recording layer can be prevented from deteriorating.

Furthermore, the main mask layer 22 is mainly composed of carbon, and a portion of the main mask layer 22 remaining over the recording element 32A is removed by dry etching that uses neither an oxygen-containing gas nor a halogen-containing gas but uses a hydrogen-containing gas in the main mask layer removing step (S114). This can also prevent the deterioration of the magnetic properties of the recording layer.

Moreover, since steps from the resin layer processing step (S104) to the protective layer deposition step (S120) are all dry processes, the deterioration of magnetic properties of the recording layer can also be prevented.

Furthermore, the intermediate mask layer processing step (S110) also serves as the main mask layer processing step such that both the intermediate mask layer 24 and the main mask layer 22 are processed into a concavo-convex pattern. Accordingly, production efficiency is improved.

Moreover, the steps from the resin layer processing step (S104) to the protective layer deposition step (S120) are all dry processes. Therefore, compared to a manufacturing method where wet processes and dry processes coexist, handling of the object to be processed 10 by conveyance and the like can be made easier. Production efficiency is improved also in this respect.

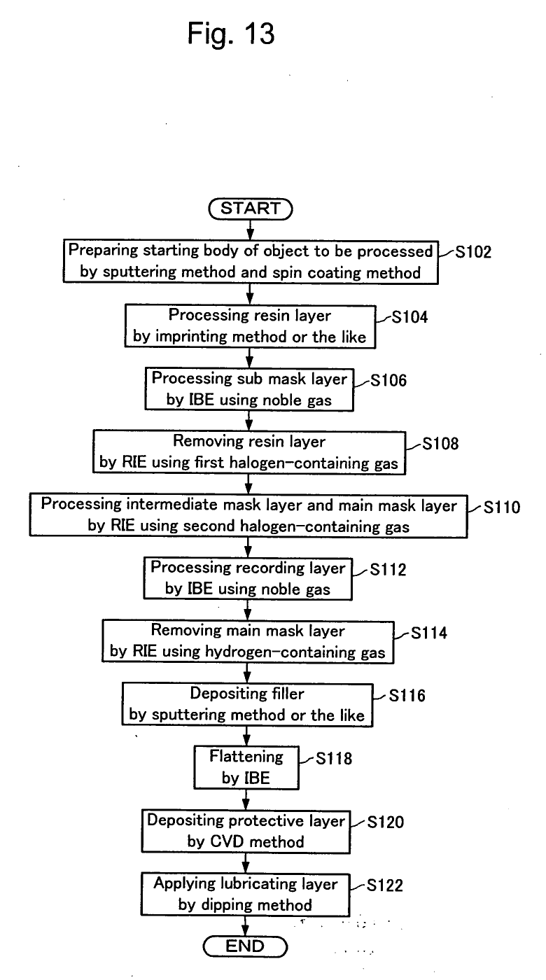

In the first exemplary embodiment of the present invention, the sub-mask layer 26 having corrosion resistance against dry etching using an oxygen-containing gas is provided over the main mask layer 22 composed mainly of carbon, and the intermediate mask layer 24 is further provided between the main mask layer 22 and the sub-mask layer 26. The intermediate mask layer 24 has corrosion resistance against the dry etching using the oxygen-containing gas, and its etching rate is higher for dry etching using a halogen-containing gas than for the dry etching using the oxygen-containing gas. The resin layer removing step (S108) is conducted between the sub-mask layer processing step (S106) and the intermediate mask layer processing step (being the main mask layer processing step) (S110), and the oxygen-containing gas is used in the resin layer removing step (S108). The halogen-containing gas is used in the intermediate mask layer processing step (being the main mask layer processing step) (S110). However, as shown in a second exemplary embodiment of the present invention illustrated in FIG. 13, the following method may also be possible. The sub-mask layer 26 having corrosion resistance against dry etching using a first halogen-containing gas containing either one of F and Cl is provided over the main mask layer 22 composed mainly of carbon, and the intermediate mask layer 24 is further provided between the main mask layer 22 and the sub-mask layer 26. The intermediate mask layer 24 has corrosion resistance against the dry etching using the first halogen-containing gas, and its etching rate is higher for dry etching using a second halogen-containing gas containing the other one of F and Cl than for the dry etching using the first halogen-containing gas. The resin layer removing step (S108) is conducted between the sub-mask layer processing step (S106) and the intermediate mask layer processing step (being the main mask layer processing step) (S110), and the first halogen-containing gas is used in the resin layer removing step (S108). The second halogen-containing gas is used in the intermediate mask layer processing step (being the main mask layer processing step) (S110).

As in the above-described first exemplary embodiment, in the second exemplary embodiment, too, the resin layer 28 can be completely removed in the resin layer processing step (S108) while simultaneously protecting the main mask layer 22. Accordingly, the main mask layer 22 can be processed into a desired pattern with high precision in the intermediate mask layer processing step (being the main mask layer processing step) (S110), thereby contributing to the improvement of processing precision of the recording elements 32A.

Moreover, since a halogen-containing gas that is highly reactive with the resin layer is used in the resin layer removing step (S108), the resin layer can be removed with greater efficiency.

Preferred combinations of a material for the intermediate mask layer 24, a material for the sub-mask layer 26, a first halogen-containing gas used in the resin layer removing step (S108), and a second halogen-containing gas used in the intermediate mask layer processing step (the main mask layer processing step) (S110) are shown in Table 2.

TABLE 2

| | second halogen- | | | |
|---|---|---|---|---|
| | containing gas | | | |
| first halogen- | (for processing | | | |
| containing gas | main mask layer and | | intermediate | main mask |
| (for removing resin layer) | intermediate mask layer) | sub mask layer | mask layer | layer |
| Cl-containing gas | CxFy, CHF₃ | Ni, Cu, Cr, Al, Al₂O₃ | SiO₂ | C |
| CCl₄, BCl₃, Cl₂, SiCl₄ | CxFy, SF₆ | | Ta, TaSi, TiN | |
| | SF₆, CF₄ | | W | |
| F-containing gas | CCl₄, BCl₃, Cl₂ | Ni | Al | |
| CxFy, SF₆, CHF₃ | Cl₂ | | Al₂O₃ | |
| | Cl₂ + O₂, CCl₄ + O₂ | | Cr | |
| | SiCl₄ + N₂, CCl₄ + Ar | | Cu | |

In the above-described first and second exemplary embodiments, the intermediate mask layer processing step (S110) also serves as the main mask layer processing step in which both the main mask layer 22 and the intermediate mask layer 24 are processed. However, the main mask layer processing step and the intermediate mask layer processing step may be separately provided. The main mask layer processing step and the intermediate mask layer processing step may use a common processing gas or different processing gases. In this instance, it should be appreciated that the main mask layer may be processed into a concavo-convex pattern based on the sub-mask layer in the main mask layer processing step. However, in the case where the sub-mask layer disappears, for example, before or during the main mask layer processing step, the main mask layer may be processed into the concavo-convex pattern based on the intermediate mask layer.

Moreover, although, in the above-described first and second exemplary embodiments, the recording layer 20 is fully partitioned during the recording layer processing step (S112), the recording layer 20 may be processed halfway in the direction of thickness such that the recording layer of the concavo-convex pattern is continuous at the bottom of the concave portions.

Moreover, although, in the above-described first and second exemplary embodiment, the soft magnetic layer 16 and the seed layer 18 are provided under the recording layer 20 (32), layer structure under the recording layer 20 (32) may be changed as needed according to the type of the magnetic recording medium. For example, an antiferromagnetic layer or an underlayer may be provided under the soft magnetic layer 16. Either the soft magnetic layer 16 or the seed layer 18 may be omitted. Furthermore, the recording layer 20 (32) may be directly formed on the substrate 12.

In the above-described first and second exemplary embodiment, the magnetic recording medium 30 is a perpendicular recording type discrete track medium in which the recording elements 32A are provided in the form of tracks within a data region. However, the present invention can also be applied to the manufacture of a patterned medium in which recording elements are provided in the form of tracks partitioned in the circumferential direction or a magnetic disk in which recording elements are provided in a spiral form. Furthermore, the present invention can also be applied to the manufacture of a magneto-optical disc such as MO, a recording disk with thermal assistance that uses both magnetism and heat, and magnetic recording media other than those having a disk shape such as magnetic tapes.

### WORKING EXAMPLE

The magnetic recording medium 30 was manufactured as described in the first exemplary embodiment. Specifically, the starting body of the object to be processed 10 was prepared (S102).

The substrate 12 had a thickness of 0.6 mm and an outer diameter of 48 mm. The diameter of the center hole was 12 mm. The substrate 12 was made of glass.

The soft magnetic layer 16 had a thickness of 100 nm and was made of a CoZrNb alloy.

The seed layer 18 had a thickness of 30 nm and was made of Ru.

The recording layer 20 (32) had a thickness of 20 nm and was made of a CoCrPt alloy.

The main mask layer 22 had a thickness of 12 nm and was made of C (carbon).

The intermediate mask layer 24 had a thickness of 3 nm and was made of Si.

The sub-mask layer 26 had a thickness of 2 nm and was made of Ni.

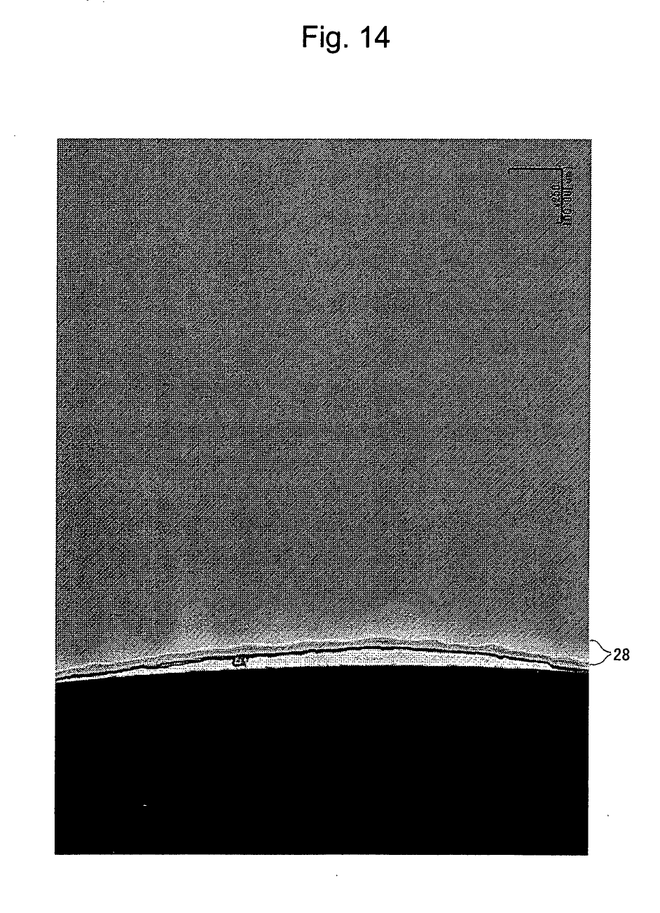

The resin layer 28 had a thickness of 70 nm and was made of an acrylic resin. The resin layer 28 was formed by a spin coating method, where the resin was applied onto the substrate 12 that was rotated at a rate of 7,000 rpm for 60 seconds. The thickness of the resin layer 28 was approximately 70 nm for regions other than the periphery of the center hole as mentioned above, but it was approximately 700 nm around the periphery of the center hole. FIG. 14 is a photograph taken under an optical microscope showing an inner circumferential part of the center hole of the substrate 12. In FIG. 14, a dark region indicates the center hole, and a lightly colored region indicates a portion of the surface of the resin layer 28 outside of the center hole in the radial direction. The thin belt-like portion formed along the contour of the center hole is a portion of the resin layer 28 that protrudes above other portions to a thickness of approximately 700 nm. Furthermore, the resin layer 28 was baked at a temperature of 90° C. for 90 seconds to be set to a predetermined hardness.

Next, a concavo-convex pattern corresponding to the concavo-convex pattern of the recording layer 32 was transferred onto the resin layer 28 by bringing the transfer surface of the stamper into contact with the resin layer 28 by an imprinting method. Then, portions of the resin layer 28 at the bottom of each of the concave portions were removed by RIE using an O₂ gas, thereby processing the resin layer 28 into the concavo-convex pattern (S104) The width of the convex portion of the line-and-space pattern in the radial direction in the data region was 65 nm. The width of the concave portion in the radial direction was also 65 nm.

Next, the sub-mask layer 26 was processed into a concavo-convex pattern corresponding to the concavo-convex pattern based on the resin layer 28 by IBE using an Ar gas (S106).

Next, portions of the resin layer 28 remaining over the sub-mask layer 26 were removed by RIE using an O₂ gas (S108). The etching condition was as follows.

Pressure in the vacuum chamber: 2 Pa

Flow rate of O₂ gas: 50 sccm

Power of the plasma source: 2,000 W

Processing time: 90 seconds

It should be noted that any bias voltage was not applied to the object to be processed 10. The resin layer 28 was completely removed, including portions in the periphery of the center hole. Conversely, the sub-mask layer 26 and the intermediate mask layer 24 hardly changed in shape.

Next, the intermediate mask layer 24 and the main mask layer 22 were processed into the concavo-convex pattern based on the sub-mask layer 26 by RIE using a CF₄ gas (a halogen-containing gas) in the same vacuum chamber (S110). The etching condition was as follows.

Pressure in the vacuum chamber: 1 Pa

Flow rate of CF₄ gas: 50 sccm

Power of the plasma source: 1,000 W

Bias power (applied to the object to be processed 10): 50 W

Processing time: 15 seconds

Next, the recording layer 20 of the continuous film was etched based on the intermediate mask layer 24 and the main mask layer 22 by IBE using an Ar gas (a noble gas), thereby forming the recording layer 32 of the concavo-convex pattern (S112). In this step, the sub-mask layer 26 and the intermediate mask layer 24 were completely removed, and only the main mask layer 22 remained over the recording elements 32A.

Next, portions of the main mask layer 22 remaining over the recording elements 32A were removed by RIE using a NH₃ gas (a hydrogen-containing gas) (S114). The etching condition was as follows.

Pressure in the vacuum chamber: 1 Pa

Flow rate of NH₃ gas: 50 sccm

Power of the plasma source: 1,000 W

Processing time of the former stage: 15 seconds

Bias power during the former stage (applied to the object to be processed 10): 15 W

Processing time of the latter stage: 30 seconds

Bias power during the latter stage: 0 W

As mentioned above, by conducting the main mask layer removing step in a plurality of stages and controlling the bias power during the last step to be smaller than the bias power of the previous step (zero bias power was applied in the present working example), deterioration of the magnetic characteristics of the recording layer can be prevented.

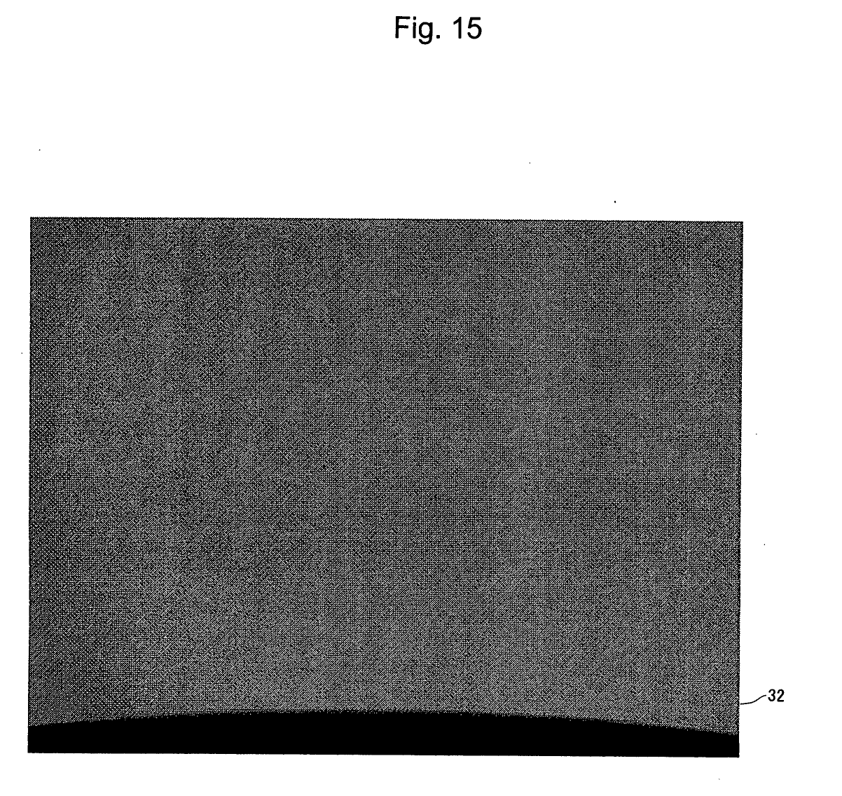

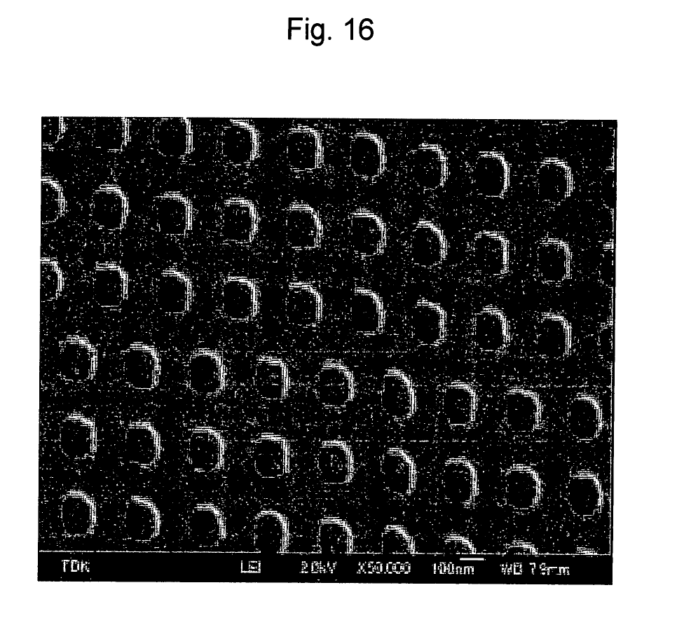

FIG. 15 is a photograph taken under an optical microscope showing the inner circumferential part of the center hole of the substrate 12 after the main mask layer removing step (S114). As can be seen from FIG. 15, no resin layer 28 was recognized in the vicinity of the inner circumferential part of the center hole of the substrate 12. Moreover, no remaining portions of the main mask layer 22, the intermediate mask layer 24, or the sub-mask layer 26 were recognized, either.

FIG. 16 is a photograph taken under SEM (a scanning electron microscope) showing a burst signal pattern in the servo region of the recording layer 32 after the main mask layer removing step (S114) In the photograph, square portions indicate the concave portions.

### Comparative Example 1

In contrast to the above Working Example, the intermediate mask layer 24 was not provided between the main mask layer 22 and the sub-mask layer 26. Moreover, the resin layer removing step (S108) was omitted. Other conditions were the same as those in the above Working Example when manufacturing the magnetic recording medium 30.

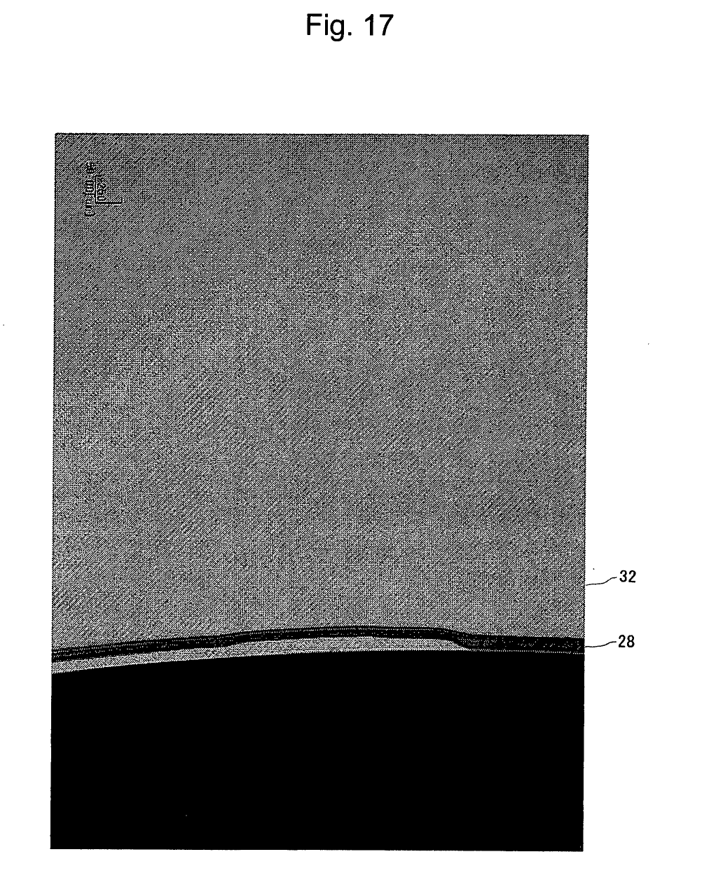

FIG. 17 is a photograph taken under an optical microscope showing the inner circumferential part of the center hole of the substrate 12 after the main mask layer removing step (S114). In FIG. 17, a dark region indicates the center hole, and a lightly colored region indicates a portion of the surface of the recording layer 32 outside of the center hole in the radial direction. The belt-like portion of an intermediate color darkness indicates a portion of the resin layer 28 that remained over the recording layer 32. As can be seen from FIG. 17, the resin layer 28 still remained along the periphery of the center hole even after the main mask layer removing step (S114).

### Comparative Example 2

In contrast to the above Working Example, the intermediate mask layer 24 was not provided between the main mask layer 22 and the sub-mask layer 26. Moreover, in the resin layer removing step (S108), bias power of approximately 50 W was applied to the object to be processed 10 in order to enhance the anisotropy of the etching so that the etching of the main mask layer 22 in the width direction was inhibited. Furthermore, the main mask layer 22 was processed into the concavo-convex pattern based on the sub-mask layer 26 in the resin layer removing step (S108). Therefore, the intermediate mask layer processing step (the main mask layer processing step) (S110) was not conducted. Other conditions were the same as those in the above Working Example when manufacturing the magnetic recording medium 30.

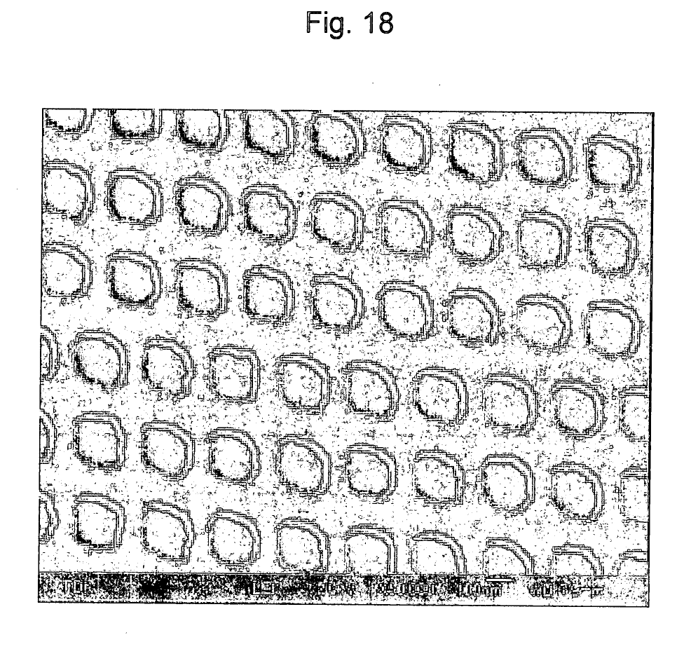

FIG. 18 is a photograph taken under SEM showing a burst signal pattern in the servo region of the recording layer 32 after the main mask layer removing step (S114). As shown in FIG. 18, the concave portion of the burst signal pattern of Comparative Example 2 had a width wider than that of the concave portion of the burst signal pattern of Working Example shown in previous FIG. 16. The reason for this was that the main mask layer 22 had been etched for a long period of time (90 seconds) in the resin layer removing step (S108). This prompted the etching of the main mask layer 22 to proceed not only in the thickness direction but also in the width direction in spite of the bias power applied to the object to be processed 10. If the bias power were not applied to the object to be processed 10 as in the resin layer removing step (S108) in the Working Example, it would be considered that the concave portion would be still wider.

What is claimed is:

1. A method for manufacturing a magnetic recording medium comprising:
a preparation step for preparing a starting body of an object s to be processed, the object including a substrate, a recording layer of continuous film made of a magnetic material, a main mask layer composed mainly of carbon, an intermediate mask layer having corrosion resistance against dry etching using an oxygen-containing gas, an etching rate of the intermediate mask layer being higher for dry etching using a halogen-containing gas than for the dry etching using the oxygen-containing gas, a sub-mask layer having corrosion resistance against the dry etching using the oxygen-containing gas, an etching rate of the sub-mask layer for the dry etching using the halogen -containing gas being lower than that of the intermediate mask layer, and a resin layer having a property that it is removed by the dry etching using the oxygen-containing gas, wherein these layers are formed in this order over the substrate;
a resin layer processing step for processing the resin layer into a predetermined concavo-convex pattern;
a sub-mask layer processing step for processing the sub-mask layer into a concavo-convex pattern corresponding to the concavo-convex pattern based on the resin layer by dry etching;
a resin layer removing step for removing a portion of the resin layer remaining over the sub-mask layer by the dry etching using the oxygen-containing gas;
an intermediate mask layer processing step for processing the intermediate mask layer into a concavo-convex pattern corresponding to the concavo-convex pattern based on the sub-mask layer by the dry etching using the halogen-containing gas;
a main mask layer processing step for processing the main mask layer into a concavo-convex pattern corresponding to the concavo-convex pattern based on at least one of the sub-mask layer and the intermediate mask layer by dry etching; and
a recording layer processing step for processing the recording layer into a concavo-convex pattern corresponding to the concavo-convex pattern based on the main mask layer by dry etching, convex portions of the concavo-convex pattern providing recording elements, wherein
these steps are conducted in this order.

2. A method for manufacturing a magnetic recording medium comprising:
a preparation step for preparing a starting body of an object to be processed, the object including a substrate, a recording layer of continuous film made of a magnetic material, a main mask layer composed mainly of carbon, an intermediate mask layer having corrosion resistance against dry etching using a first halogen-containing gas containing either one of F and Cl, an etching rate of the intermediate mask layer being higher for dry etching using a second halogen-containing gas containing the other one of F and Cl than for the dry etching using the first halogen-containing gas, a sub-mask layer having corrosion resistance against the dry etching using the first halogen-containing gas, an etching rate of the sub-mask layer for the dry etching using the second halogen-containing gas being lower than that of the intermediate mask layer, and a resin layer having a property that it is removed by the dry etching using the first halogen-containing gas, wherein these layers are formed in this order over the substrate;
a resin layer processing step for processing the resin layer into a predetermined concavo-convex pattern;
a sub-mask layer processing step for processing the sub-mask layer into a concavo-convex pattern corresponding to the concavo-convex pattern based on the resin layer by dry etching;
a resin layer removing step for removing a portion of the resin layer remaining over the sub-mask layer by the dry etching using the first halogen-containing gas;
an intermediate mask layer processing step for processing the intermediate mask layer into a concavo-convex pattern corresponding to the concavo-convex pattern based on the sub-mask layer by the dry etching using the second halogen-containing gas;
a main mask layer processing step for processing the main mask layer into a concavo-convex pattern corresponding to the concavo-convex pattern based on at least one of the sub-mask layer and the intermediate mask layer by dry etching; and
a recording layer processing step for processing the recording layer into a concavo-convex pattern corresponding to the concavo-convex pattern based on the main mask layer by dry etching, convex portions of the concavo-convex pattern providing recording elements, wherein
these steps are conducted in this order.

3. The method for manufacturing a magnetic recording medium according to claim 1, wherein
the intermediate mask layer processing step also serves as the main mask layer processing step such that the intermediate mask layer and the main mask layer are processed based on the sub-mask layer in the intermediate mask layer processing step.

4. The method for manufacturing a magnetic recording medium according to claim 2, wherein
the intermediate mask layer processing step also serves as the main mask layer processing step such that the intermediate mask layer and the main mask layer are processed based on the sub-mask layer in the intermediate mask layer processing step.

5. The method for manufacturing a magnetic recording medium according to claim 1, further comprising, after the recording layer processing step, a main mask layer removing step for removing portions of the main mask layer remaining over the recording elements by dry etching.

6. The method for manufacturing a magnetic recording medium according to claim 2, further comprising, after the recording layer processing step, a main mask layer removing step for removing portions of the main mask layer remaining over the recording elements by dry etching.

7. The method for manufacturing a magnetic recording medium according to claim 3, further comprising, after the recording layer processing step, a main mask layer removing step for removing portions of the main mask layer remaining over the recording elements by dry etching.

8. The method for manufacturing a magnetic recording medium according to claim 4, further comprising, after the recording layer processing step, a main mask layer removing step for removing portions of the main mask layer remaining over the recording elements by dry etching.

9. The method for manufacturing a magnetic recording medium according to claim 5, wherein
the portions of the main mask layer remaining over the recording elements are removed by dry etching using a hydrogen-containing gas in the main mask layer removing step.

10. The method for manufacturing a magnetic recording medium according to claim 6, wherein
the portions of the main mask layer remaining over the recording elements are removed by dry etching using a hydrogen-containing gas in the main mask layer removing step.

11. The method for manufacturing a magnetic recording medium according to claim 7, wherein
the portions of the main mask layer remaining over the recording elements are removed by dry etching using a hydrogen-containing gas in the main mask layer removing step.

12. The method for manufacturing a magnetic recording medium according to claim 8, wherein
the portions of the main mask layer remaining over the recording elements are removed by dry etching using a hydrogen-containing gas in the main mask layer removing step.
